(19) United States
(12) Patent Application Publication
(10) Pub. No.: US 2025/0118826 A1
(43) Pub. Date: Apr. 10, 2025

(54) COOLING SYSTEM MANIFOLD FOR A BATTERY MODULE

(71) Applicant: GM Global Technology Operations LLC, Detroit, MI (US)

(72) Inventors: Drew Brennan, Holland, MI (US); Jack G. Michalski, Ferndale, MI (US)

(21) Appl. No.: 18/483,810

(22) Filed: Oct. 10, 2023

(51) Int. Cl. H01M 10/6557; F16B 5/02; H01M 10/613; H01M 10/6555; H01M 10/6568; H01M 50/213

(52) U.S. Cl. CPC H01M 10/6557; F16B 5/02; H01M 10/613; H01M 10/6555; H01M 10/6568; H01M 50/213; H01M 2220/20

(57) ABSTRACT

A cooling system manifold for a battery module having at least one battery cell and at least one temperature regulating component having a flow path with a feed port and return port to receive and discharge coolant. The cooling system manifold being removably attachable to the battery module for supplying and/or removing coolant to the temperature regulating component and being separately formed with first and second portions that are joined together and form internal coolant flow channels. The first portion having an access feature for removing coolant from or directing coolant into the coolant flow channel and a second portion having engagement openings that provide coolant flow paths between the coolant flow channel and the temperature regulating component. The manifold having integrated seals that seal against the engagement openings and temperature regulating component, counter bores that inhibit removal, and back stops that limit movement of the seals.

### INTRODUCTION

The present disclosure relates to a cooling system manifold for a battery module that is part of a rechargeable energy storage system. More particularly, the present disclosure relates to a removable manifold with an integrated seal for providing heat transfer fluid flow for a cooled battery module.

Electric vehicles and hybrid vehicles employ a high voltage rechargeable energy storage system that includes a number of battery modules that each include a number of battery cells. These electric and hybrid vehicles typically require several battery cells to provide enough power to meet vehicle power and energy requirements. The battery modules are often located under the vehicle body midway between the front and rear wheels.

Battery cells, particularly of the high-voltage type described above, generate substantial amounts of heat during sustained operation. Over time, the generated heat may degrade the efficiency and the overall structural integrity of the battery module. Thermal management systems are therefore used to closely regulate the temperature of the battery module. In one type of thermal management system, heat transfer fluid is circulated to and from temperature regulating components, such as ribbons or cooling plates, interspaced between the battery cells. The cooling systems have sealing elements integrated into the ribbons or cooling plates and are not serviceable. While effective, there is a need in the art for improved coolant system designs to allow for in-line rework or service of the cooling system.

### SUMMARY

A cooling system manifold for a battery module is provided. The battery module has at least one battery cell and at least one temperature regulating component that has a flow path with a feed port to receive coolant and a return port to discharge coolant. The cooling system manifold includes a supply manifold attachable to the battery module for supplying coolant to the at least one temperature regulating component in the battery module and has separately formed a supply manifold first portion connected to a supply manifold second portion and form an internal supply channel. The supply manifold first portion has a supply port that directs coolant into the internal supply channel and the supply manifold second portion has an outlet that directs coolant from the internal supply channel to the feed port. A first seal is disposed within the outlet and has a first section sealed against the outlet and a second section sealable to the feed port. The cooling system manifold includes a removable manifold attachable to the battery module for removing coolant from the at least one temperature regulating component in the battery module and has separately formed a removal manifold first portion connected to a removal manifold second portion and form an internal removal channel. The removal manifold first portion has a removal port that directs coolant out of the internal removal channel and the removal manifold second portion has an inlet that directs coolant from the return port to the internal removal channel. A second seal is disposed within the inlet and has a first section sealed against the inlet and a second section sealable to the return port.

In one aspect, the supply manifold second portion includes multiple attachment sections that are attached to the battery module with removable fasteners, and the removal manifold second portion has multiple attachment sections that are attached to the battery module with removable fasteners.

In another aspect, the cooling system manifold includes compression limiters disposed in the supply manifold second portion attachment sections and in the removal manifold second portion attachment sections. The compression limiters limit compression of the supply manifold attachment sections by the removable fasteners attaching the supply manifold to the battery module and limit compression the removal manifold attachment sections by the removable fasteners attaching the removal manifold to the battery module.

In another aspect, the supply manifold second portion attachment sections have two alignment holes that receive insertion of alignment pins on the battery module and align the supply manifold with the battery module, and the removal manifold second portion attachment sections have two alignment holes that receive insertion of alignment pins on the battery module and align the removal manifold with the battery module.

In another aspect, a coolant supply line has a supply attachment bracket and supplies coolant to the supply manifold and a coolant return line has a return attachment bracket and removes coolant from the removal manifold. The supply manifold first portion has a removable fastener engagement opening adjacent the supply port and the removal manifold first portion has a removable fastener engagement opening adjacent the removal port. The coolant supply line is attached to the supply port with the supply attachment bracket attached to the supply manifold with a fastener in the supply manifold fastener engagement opening, and the coolant return line is attached to the removal port with the return attachment bracket attached to the removal manifold with a fastener in the removal manifold fastener engagement opening.

In another aspect, the supply manifold first portion and the supply manifold second portion are separately injection molded and include joining elements that join the supply manifold first portion to the supply manifold second portion and forms a seal that maintains coolant in the internal supply channel, the first seal is disposed within the outlet either prior to or after joining together the supply manifold first portion and the supply manifold second portion, the removal manifold first portion and the removal manifold second portion are separately injection molded and include joining elements that join the removal manifold first portion to the removal manifold second portion and forms a seal that maintains coolant in the internal removal channel, and the second seal is disposed within the inlet either prior to or after joining together the removal manifold first portion and the removal manifold second portion.

In another aspect, the supply manifold first portion includes a back stop formed in the injection molding that aligns with the outlet, wherein the supply manifold back stop limits movement of the first seal in the outlet toward the supply manifold first portion, the removal manifold first portion includes a back stop formed in the injection molding that aligns with the inlet, and wherein the removal manifold back stop limits movement of the second seal in the inlet toward the removal manifold first portion.

In another aspect, the outlet includes an inner surface, the outlet inner surface has a step feature formed in the injection molding, the first seal first section has an outer diameter that contacts the outlet step feature and inhibits removal of the first seal from the outlet away from the supply manifold first portion and enables the supply manifold to be removed from the battery module with the first seal remaining in the supply manifold, and the inlet includes an inner surface, the inlet inner surface has a step feature formed in the injection molding, the second seal first section has an outer diameter that contacts the inlet step feature and inhibits removal of the second seal from the inlet away from the removal manifold first portion and enables the removal manifold to be removed from the battery module with the second seal remaining in the removal manifold.

In another embodiment, a cooling system manifold for a battery module is provided. The battery module has at least one battery cell and at least one temperature regulating component having a flow path with a feed port to receive coolant and a return port to discharge coolant. The cooling system manifold includes a manifold attachable to the battery module for supplying coolant to and removing coolant from the at least one temperature regulating component in the battery module and has separately formed a manifold first portion connected to a manifold second portion and form an internal supply channel and an internal removal channel. The manifold first portion has a supply port that directs coolant into the internal supply channel and a removal port that directs coolant out of the internal removal channel and the manifold second portion has an outlet that directs coolant from the internal supply channel to the feed port and an inlet that directs coolant from the return port to the internal removal channel. A first seal is disposed within the outlet and has a first section sealed against the outlet and a second section sealable to the feed port. A second seal is disposed within the inlet and has a first section sealed against the inlet and a second section sealable to the return port.

In one aspect, the manifold second portion has multiple attachment sections that are attached to the battery module with removable fasteners.

In another aspect, the cooling system manifold includes compression limiters disposed in the attachment sections. The compression limiters limit compression of the attachment sections by the removable fasteners attaching the manifold to the battery module.

In another aspect, the attachment sections have two alignment holes that receive insertion of alignment pins on the battery module and align the manifold with the battery module.

In another aspect, a coolant supply line has a supply attachment bracket and supplies coolant to the manifold and a coolant return line has a return attachment bracket and removes coolant from the manifold. The manifold first portion has a removable fastener engagement opening adjacent the supply port and the manifold first portion has a removable fastener engagement opening adjacent the removal port. The coolant supply line is attached to the supply port with the supply attachment bracket attached to the manifold with a fastener in the fastener engagement opening adjacent the supply port, and the coolant return line is attached to the removal port with the return attachment bracket attached to the manifold with a fastener in the fastener engagement opening adjacent the removal port.

In another aspect, the manifold first portion and the manifold second portion are separately injection molded and include joining elements that join the manifold first portion to the manifold second portion and forms a seal that maintains coolant in the internal supply channel and in the internal removal channel, the first seal is disposed within the outlet either prior to or after joining together the manifold first portion and the manifold second portion, and the second seal is disposed within the inlet either prior to or after joining together the manifold first portion and the manifold second portion.

In another aspect, the manifold first portion includes back stops formed in the injection molding that align with the outlet and the inlet, wherein the back stops limit movement of the first seal in the outlet toward the first portion and the second seal in the inlet toward the first portion.

In another aspect, the outlet includes an inner surface, the outlet inner surface has a step feature formed in the injection molding, the first seal first section has an outer diameter that contacts the outlet step feature and inhibits removal of the first seal from the outlet away from the first portion and enables the manifold to be removed from the battery module with the first seal remaining in the manifold, and the inlet includes an inner surface, the inlet inner surface has a step feature formed in the injection molding, the second seal first section has an outer diameter that contacts the inlet step feature and inhibits removal of the second seal from the inlet away from the first portion and enables the manifold to be removed from the battery module with the second seal remaining in the manifold.

In yet another embodiment, a battery module is provided. The battery module includes a battery tray, a plurality of battery cells supported on the battery tray, a plurality of temperature regulating components each having a flow path with a feed port and a return port to receive and discharge coolant, and a cooling assembly. The cooling assembly includes a manifold attachable to the battery module for supplying coolant to and removing coolant from the temperature regulating components in the battery module and has separately formed a manifold first portion connected to a manifold second portion and form an internal supply channel and an internal removal channel. The manifold first portion has a supply port that directs coolant into the internal supply channel and a removal port that directs coolant out of the internal removal channel. The manifold second portion has outlets that direct coolant from the internal supply channel to the feed ports and inlets that direct coolant from the return ports to the internal removal channel. First seals are disposed within the outlets, the first seals have a first section sealed against the outlet and a second section sealable to the feed port. Second seals are disposed within the inlets, the second seals have a first section sealed against the inlet and a second section sealable to the return port.

In another aspect, a coolant supply line has a supply attachment bracket that supplies coolant to the manifold and a coolant return line has a return attachment bracket that removes coolant from the manifold. The manifold first portion has a removable fastener engagement opening adjacent the supply port and has a removable fastener engagement opening adjacent the removal port. The coolant supply line is attached to the supply port with the supply attachment bracket attached to the manifold with a fastener in the fastener engagement opening adjacent the supply port, and the coolant return line is attached to the removal port with the return attachment bracket attached to the manifold with a fastener in the fastener engagement opening adjacent the removal port.

In another aspect, the manifold first portion and the manifold second portion are separately injection molded and include joining elements that join the manifold first portion to the manifold second portion and forms a seal that maintains coolant in the internal supply channel and in the internal removal channel, the first seals are disposed within the outlets either prior to or after joining together the manifold first portion and the manifold second portion, and the second seals are disposed within the inlets either prior to or after joining together the manifold first portion and the manifold second portion.

In another aspect, the manifold first portion includes back stops formed in the injection molding that align with the manifold second portion outlets and inlets, wherein the back stops limit movement of the first seals in the outlets toward the first portion and the second seals in the inlets toward the first portion, the outlets include an inner surface, the outlet inner surfaces have a step feature formed in the injection molding, the first seal first sections have an outer diameter that contacts the outlet step features and inhibits removal of the first seals from the outlets away from the first portion and enables the manifold to be removed from the battery module with the first seals remaining in the manifold, and the inlets include an inner surface, the inlet inner surfaces have a step feature formed in the injection molding, the second seal first sections have an outer diameter that contacts the inlet step features and inhibits removal of the second seals from the inlets away from the first portion and enables the manifold to be removed from the battery module with the second seals remaining in the manifold.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is schematic view of an exemplary motor vehicle having a rechargeable energy storage system with multiple battery modules and a cooling assembly according to the principles of the present disclosure;

FIG. 2 is an isometric perspective view of battery modules with the cooling assembly;

FIG. 3 is an isometric perspective view of temperature regulating components and batteries of a battery module;

FIG. 4 is an isometric perspective view of a dual function manifold according to the principles of the present disclosure;

FIG. 5A is an isometric perspective view of a first portion of a dual function manifold according to the principles of the present disclosure;

FIG. 5B is an isometric perspective view of a second portion of a dual function manifold according to the principles of the present disclosure;

FIG. 5C is an isometric perspective view of the attaching of a first and second portion of a dual function manifold according to the principles of the present disclosure;

FIG. 6A is an isometric perspective view of a first portion of a single function manifold according to the principles of the present disclosure;

FIG. 6B is an isometric perspective view of a second portion of a single function manifold according to the principles of the present disclosure;

FIG. 6C is an isometric perspective view of the attaching of a first and second portion of a single function manifold according to the principles of the present disclosure;

FIG. 7 is an isometric perspective view of a seal;

FIG. 8 is a cross-sectional view of the dual function manifold viewed in the direction of arrows 8-8 in FIG. 4;

FIG. 9 is a cross-sectional view of a formed single function manifold viewed in the direction of arrows 9-9 in FIG. 6C;

FIG. 10 is a cross-sectional view of the dual function manifold attached to a battery module viewed in the direction of arrows 10-10 in FIG. 2;

FIG. 11 is a cross-sectional view of a single function manifold attached to a battery module viewed in the direction of arrows 11-11 in FIG. 2;

FIG. 12 is an isometric perspective view of a compression limiter; and

FIG. 13 is an isometric perspective view an attachment section of a manifold.

### DETAILED DESCRIPTION

The following description is merely exemplary in nature and is not intended to limit the present disclosure, application, or uses.

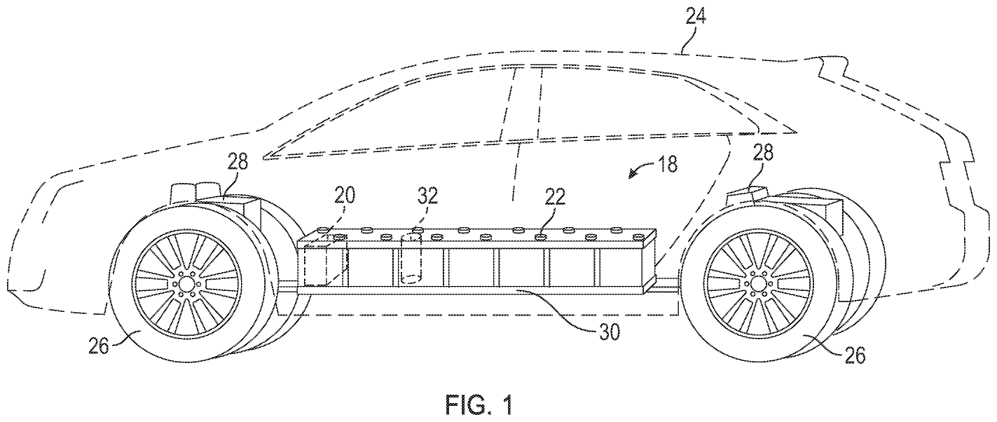

Referring to FIG. 1, a rechargeable energy storage system 18 having a cooling assembly 20 and battery modules 22 according to the principles of the present disclosure is shown. The cooling assembly 20 is configured to provide cooling to the battery modules 22, as will be described in greater detail below. The rechargeable energy storage system 18 is illustrated with a vehicle 24. The vehicle 24 shown is exemplary. The vehicle 24 is preferably an electric vehicle or hybrid vehicle having wheels 26 driven by electric motors/inverters 28. The electric motors/inverters 28 receive motive power from the battery modules 22. While the vehicle 24 is illustrated as a passenger road vehicle, it should be appreciated that the cooling assembly 20 and the battery modules 22 may be used with various other types of vehicles. For example, cooling assembly 20 and the battery modules 22 may be used in nautical vehicles, such as boats, or aeronautical vehicles, such as drones or passenger airplanes. Moreover, the cooling assembly 20 and the battery modules 22 may be used as a stationary power source separate and independent from a vehicle.

The rechargeable energy storage system 18 generally includes a battery tray 30 connected to the vehicle 24. The battery tray 30 provides structural support to one or a plurality of battery cells 32 (only one of which is shown) disposed within the battery modules 22. The battery cells 32 can be cylindrical lithium-ion battery cells, as shown. However, it should be appreciated that any type of battery cell 32 may be employed so long as the battery cell 32 is compatible with the cooling assembly 20.

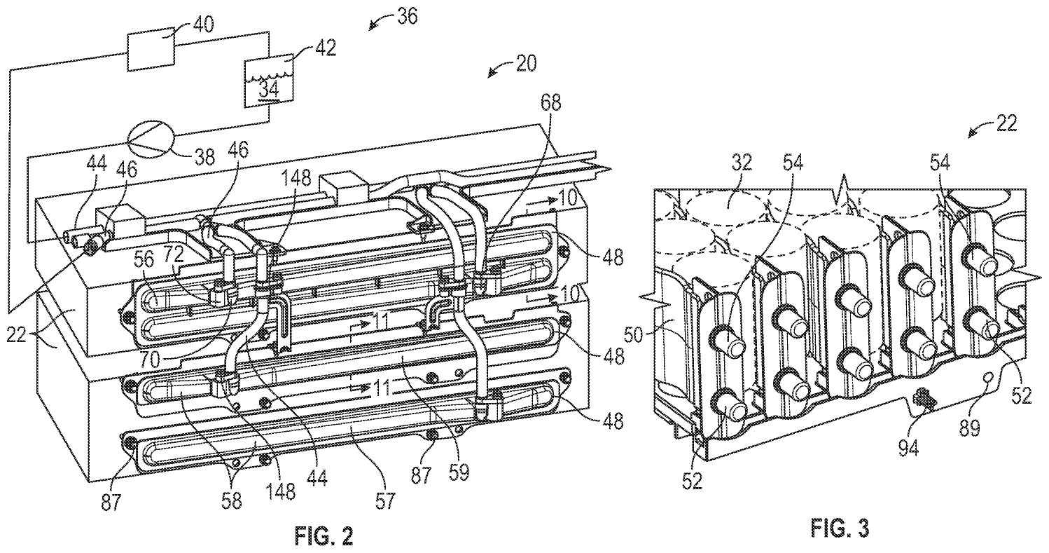

Referring now to FIGS. 2 and 3, the cooling assembly 20 is illustrated relative to two exemplary versions of the battery modules 22. The cooling assembly 20 is configured to circulate a coolant 34 therethrough in order to cool the battery cells 32 in the battery modules 22 via heat transfer. The cooling assembly 20 forms part of a larger battery thermal management system 36 that generally includes a pump 38, a heat exchanger 40, and a recovery tank 42. The battery thermal management system 36 may include various other components including temperature and humidity sensors, heating, ventilation, and air conditioning (HVAC) components, valves, and electronic controllers, without departing from the scope of the present disclosure. Generally, the pump 38 is in fluid communication with the recovery tank 42 and pumps the coolant 34 from the recovery tank 42 to a coolant supply line 44 of the cooling assembly 20. The cooling assembly 20 routes the coolant 34 to the battery modules 22 in order to cool the battery cells 32. The coolant 34 is subsequently returned from the cooling assembly 20 through a coolant return line 46 and communicated to the heat exchanger 40. The heat exchanger 40 removes heat from the coolant 34, for example, using a liquid to air heat exchanger with a fan, though other types of heat exchangers may be employed. The coolant 34 is returned to the recovery tank 42.

The cooling assembly 20 includes one or more removable manifolds 48 connected to temperature regulating components 50 in the battery module 22. The removable manifolds 48 supply coolant 34 to and remove coolant 34 from a coolant flow path in the temperature regulating components 50 to regulate the temperature of the battery cells 32 in the battery module 22. The temperature regulating components 50 can take various forms based on the shape or type of battery cells 32 in the battery module 22. For example, as shown in FIG. 3, the temperature regulating components 50 can be ribbons to accommodate battery cells 32 that are cylindrical in shape. Other shapes of the temperature regulating components 50 include a relatively flat surface to accommodate flat surface battery cells and may be referred to as a coolant plate. The temperature regulating components 50 have a feed port 52 and a return port 54 to supply coolant 34 to and remove coolant 34 from the internal coolant flow path. The feed ports 52 are typically located below the return ports 54 so that coolant 34 flowing through the internal coolant flow path enters at a low level and exits at a higher level. The manifolds 48 can take various functional forms to engage with the temperature regulating components 50 in the battery module 22. For example, the manifold 48 can be a dual function manifold 56 that supplies coolant 34 to and removes coolant 34 from a temperature regulating component 50 or can be a single function manifold 58 that is either a supply manifold 57 that supplies coolant 34 to a temperature regulating component 50 or a removal manifold 59 that removes coolant 34 from a temperature regulating component 50. As described in detail below, each of these manifolds 48 have separately formed portions that are joined together and the single function manifold 58 will have a single internal flow channel to support a single coolant flow function and the dual function manifold 56 will have two internal flow channels to support two coolant flow functions. The portions are separately formed via injection molding and can be made from a variety of materials, for example polyamide, polypropylene, and glass reinforced PA66+GF30. Various other materials may be used and are selected to provide the desired functionality and capabilities.

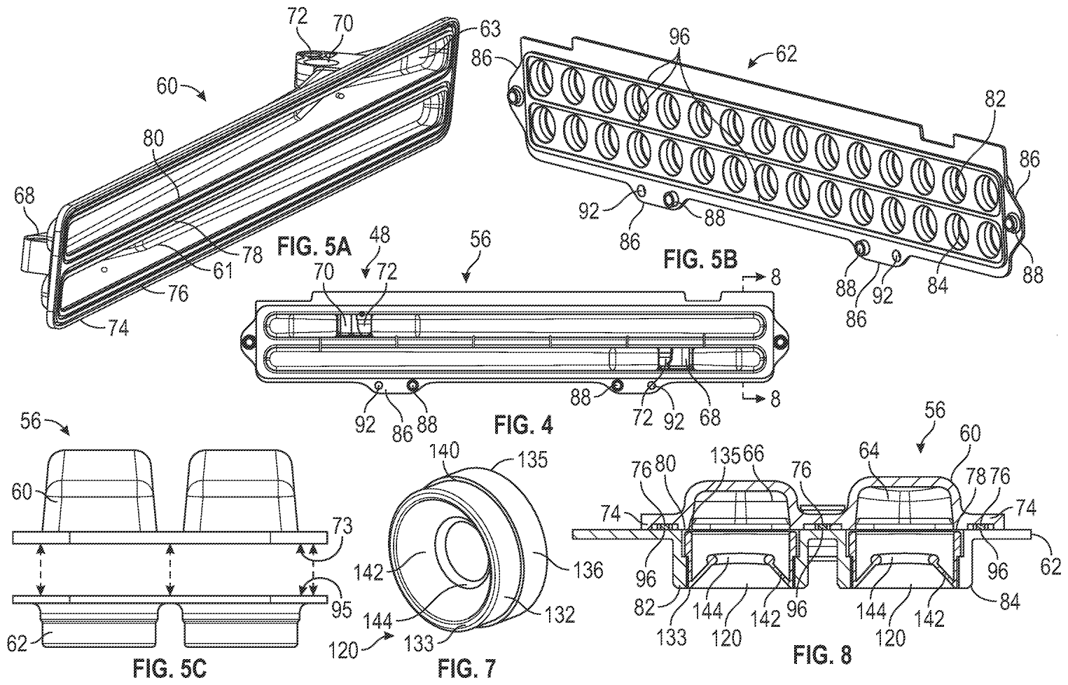

Referring to FIGS. 2, 4, 5A, 5B, 5C and 8, the dual function manifold 56 includes a first portion 60 and a second portion 62. Each portion 60, 62 is separately formed via injection molding and can be created from a variety of materials as described above and are connected together to form the dual function manifold 56. The first portion 60 includes a first cavity 61 and a second cavity 63 that respectively form an internal supply flow channel 64 and an internal removal flow channel 66 when connected with the second portion 62. The first portion 60 includes a supply port 68 for receiving coolant 34 from coolant supply line 44 and directing received coolant 34 into the internal supply flow channel 64, a removal port 70 for receiving coolant 34 from the internal removal flow channel 66 and directing received coolant 34 into coolant return line 46, and removable fastener engaging features 72 adjacent the supply port 68 and removal port 70 to receive a removable fastener, such as a threaded bolt, to attach the respective coolant supply line 44 and coolant return line 46. The removable fastener engaging feature 72 may be an opening and can include a threaded insert that may be overmolded in the first portion 60. The first portion 60 has an internal surface 73 that faces the second portion 62 and includes a first rib 74 that extends along the perimeter, a second rib 76 that extends adjacent the perimeter inside of the first rib 74 and between the cavities 61 and 63, a third rib 78 that encircles the first cavity 61 inside of the second rib 76, and a fourth rib 80 that encircles the second cavity 63 inside of the second rib 76. As described below, the third and fourth ribs 78, 80 act as back stops to the seals 120.

The second portion 62 includes inlets 82 that direct received coolant 34 from the return ports 54 of temperature regulating components 50 into the internal removal flow channel 66, and outlets 84 that direct coolant 34 from the internal supply flow channel 64 into feed ports 52 of temperature regulating components 50. Referring also to FIGS. 12 and 13, the second portion 62 includes attachment sections 86 having a fastener hole 88. The battery module 22 has a fastener engaging feature 89. The fastener engaging feature 89 can be a threaded opening. A removable fastener 87, such as a threaded bolt, can attach the dual function manifold 56 to the battery module 22 via the fastener engaging feature 89. The fastener holes 88 may include a compression limiter 90 through which the removable fastener 87 is inserted. The compression limiter 90 limits the compression applied to the attachment section 86 when attached to the battery module 22. The compression limiter 90 may be overmolded in the attachment section 86 or cold or hot pressed through the fastener hole 88. The attachment sections 86 may have an alignment hole 92 to receive insertion of an alignment pin 94 on the battery module 22, shown in FIG. 3, and cause alignment of the dual function manifold 56 with the battery module 22. The alignment should be capable through engagement with at least two alignment pins 94. The second portion 62 has an internal surface 95 that faces the internal surface 73 of the first portion 60 and includes a rib 96 that extends along the perimeter adjacent the inlets 82 and outlets 84 and between the inlets 82 and outlets 84.

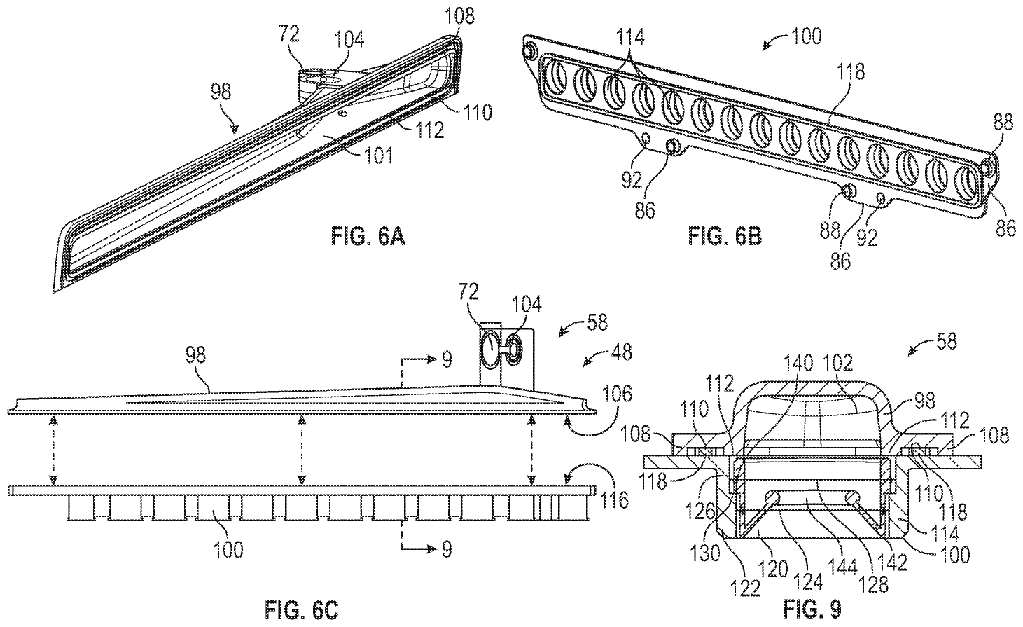

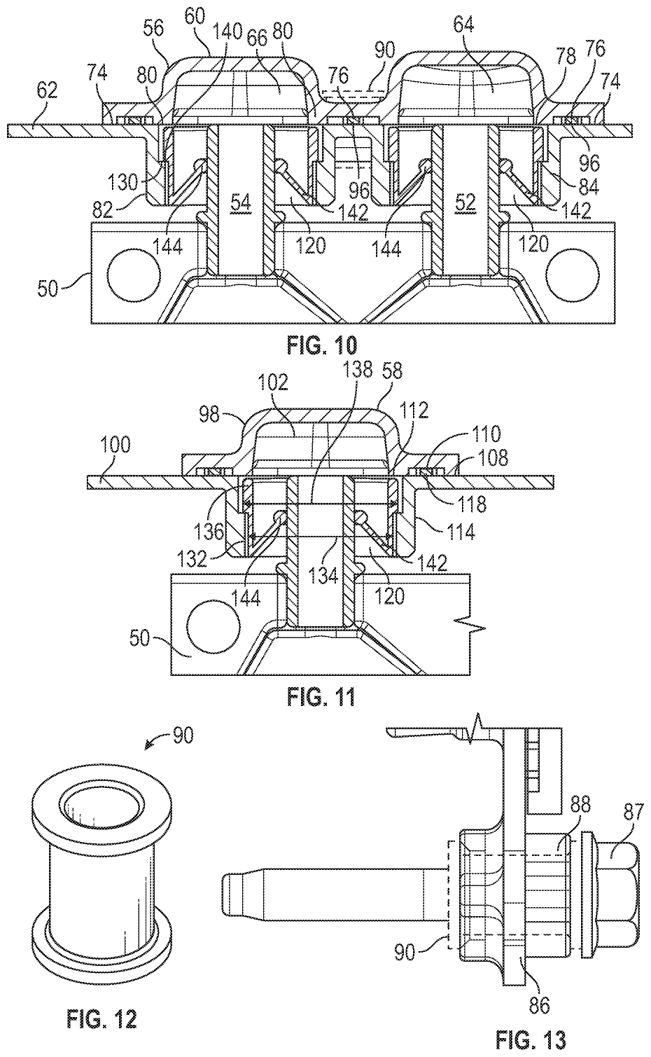

Referring to FIGS. 2, 6A, 6B, 6C, and 9, the single function manifold 58 includes a first portion 98 and a second portion 100. Each portion 98, 100 is separately formed via injection molding and can be created from a variety of materials as described above and are connected together to form the single function manifold 58. The first portion 98 includes a cavity 101 that forms an internal flow channel 102 when connected with the second portion 100. The internal flow channel 102 will function to either receive coolant 34 from a coolant supply line 44 when part of a supply manifold 57 or return coolant 34 to a coolant return line 46 when part of a removal manifold 59. The first portion 98 includes an access feature 104 that provides access to internal flow channel 102 and a removable fastener engaging feature 72 adjacent the access feature 104 to receive a removable fastener, such as a threaded bolt, to attach the coolant supply line 44 when part of a supply manifold 57 or the coolant return line 46 when part of a removal manifold 59. Access feature 104 will function as a supply port for receiving coolant 34 from coolant supply line 44 and directing received coolant 34 into the internal flow channel 102 when part of a supply manifold 57 or as a removal port for returning coolant 34 from the internal flow channel 102 to coolant return line 46 when part of a removal manifold 59. The removable fastener engaging feature 72 may be an opening and can include a threaded insert that may be overmolded in the first portion 98. The first portion 98 has an internal surface 106 that faces the second portion 100 and includes a first rib 108 that extends along the perimeter, a second rib 110 that extends adjacent the perimeter inside of the first rib 108, and a third rib 112 that encircles the cavity 101 inside of the second rib 110. As described below, the third rib 112 acts as a back stop to the seals 120.

The second portion 100 includes engagement openings 114 that provide coolant flow paths between the internal flow channel 102 and the temperature regulating components 50 in a battery module 22. The engagement openings 114 function as inlets that engage with return ports 54 on a temperature regulating component 50 and direct received coolant 34 from the return ports 54 into the internal flow channel 102 when part of a removal manifold 59 or as outlets that engage with feed ports 52 on a temperature regulating component 50 and direct coolant 34 from the internal flow channel 102 into the feed ports 52 when part of a supply manifold 57. The second portion 100 includes attachment sections 86 having a fastener hole 88 to receive a removable fastener, such as a thread bolt, to attach the single function manifold 58 to the battery module 22 via a removable fastener engaging feature 89 on the battery module 22, such as a threaded receiving opening. Fastener holes 88 may include a compression limiter 90 through which the removable fastener may extend which limits the compression applied to the attachment section 86 when attached to the battery module 22. The compression limiters 90 may be overmolded in the attachment sections 86 and fastener holes 88 or cold or hot pressed through the associated fastener holes 88. The attachment sections 86 may have an alignment hole 92 to receive insertion of an alignment pin 94 on the battery module 22, shown in FIG. 3, and cause alignment of the single function manifold 58 with the battery module 22. The alignment should be capable through engagement with at least two alignment pins 94. The second portion 100 has an internal surface 116 that faces the internal surface 106 of the first portion 98 and includes a rib 118 that extends along the perimeter adjacent the engagement openings 114.

Referring to FIGS. 50, 60, 8, and 9, the dual function manifold 56 is formed by connecting together the first and second portions 60, 62 and the single function manifold 58 is formed by connecting together the first and second portions 98, 100. The first and second portions 60, 62 and 98, 100 are aligned with one another and can be connected together in a variety of manners. As described below, ribs on the portions engage with one another to form the manifold 48. In the dual function manifold 56, the second rib 76 on the first portion 60 is aligned with the rib 96 on the second portion 62. In the single function manifold 58, the second rib 110 on the first portion 98 is aligned with the rib 118 on the second portion 100. The aligned ribs 76, 96 and 110, 118 can be joined together by friction welding, ultrasonic welding, laser welding, and an adhesive. Other joining processes could also be utilized. The joined ribs 76, 96 connect the first and second portions 60, 62 of the dual function manifold 56 and form a seal around the internal supply and removal flow channels 64, 66 to maintain the coolant 34 therein. The joined ribs 110, 118 connect the first and second portions 98, 100 of the single function manifold 58 and form a seal around the internal flow channel 102 to maintain the coolant 34 therein. A seal (not shown) could also be placed between the first and second portions 60, 62 and 98, 100 to provide additional sealing.

Referring to FIGS. 7, 8, 9,10 and 11, the manifolds 48 include seals 120 that are integrated into the inlets 82 and outlets 84 of the second portion 62 of the dual function manifolds 56 and into the engagement openings 114 of the second portion 100 of the single function manifolds 58. The seals 120 have an exterior section that seals against the inlets 82, outlets 84 and engagement openings 114 and an interior section that is sealable to the feed ports 52 and return ports 54. Each of the inlets 82, outlets 84 and engagement openings 114, as shown by example in FIG. 9 have a generally cylindrical interior inner surface with a first section 122 having a first interior diameter 124 and a second section 126 having a second interior diameter 128 that is larger than the first interior diameter 124. The second section 126 is adjacent to the first portion. The larger second interior diameter 128 forms a counter bore with a step feature 130 between the first and second sections 122, 126. The seals 120 are made from a flexible material, such as ethylene propylene diene monomer (EDPM) rubber to seal against the associated manifold 48 and feed ports 52 and return ports 54 of associated temperature regulating components 50. The seals 120 have opposite first and second ends 133, 135 and a generally cylindrical exterior with a first section 132 adjacent the first end 133 and having a first outer diameter 134 and a second section 136 adjacent the second end 135 and having a second outer diameter 138 that is larger than the first outer diameter 134. The differing outer diameters 134, 138 forms a ridge 140 on the seals 120 between the first and second sections 132, 136. The size of the second outer diameter 138 may change along the second portion 136 with the largest portion being adjacent the ridge 140 and the smallest portion being adjacent the second end 135. The seals 120 have a generally cylindrical interior extending from the second end 135 to the first end 133 and a flexible interior circular sealing wall 142 that extends in the interior from the first end 133 toward the second end 135 and has an end ridge 144. The inner diameter of the sealing wall 142 decreases in size as it extends from the first end 133 to the end ridge 144 and the end ridge 144 has an interior diameter that is smaller than the exterior diameter of the feed port 52 and return port 54 of the temperature regulating components 50. The sealing wall 142 engages with and seals against an inserted feed port 52 or return port 54 of a temperature regulating component 50 which passes through and seals against the end ridge 144. The seals 120 may have internal rigid bushing to limit compression of the seal 120.

The seals 120 may be integrated into the associated manifold 48 either prior to or after joining the associated first and second portions 60, 62 and 98, 100 of the respective dual function manifold 56 and single function manifold 58 by inserting the seals 120 into the inlets 82 and outlets 84 of the second portion 62 of the dual function manifolds 56 and into the engagement openings 114 of the second portion 100 of the single function manifolds 58. The third and fourth ribs 78, 80 of the first portion 60 of the dual function manifold 58 align with the respective inlets 82 and outlets 84 of the second portion 62 of the dual function manifold 56. The third and fourth ribs 78, 80 form back stops that can engage with the second ends 135 of the seals 120 and limit movement of the seals 120 within the associated inlets 82 and outlets 84 toward the first portion 60 of the dual function manifold 56. The third rib 112 of the first portion 98 of the single function manifold 58 aligns with the engagement openings 114 of the second portion 100 of the single function manifold 58. The third rib 112 forms a back stop that can engage with the second ends 135 of the seals 120 and limit movement of the seals 120 within engagement openings 114 toward the first portion 98 of the single function manifold 58. The step feature 130, as described below is a retaining feature as it retains seals 120 within the manifolds 48, 56, 57, 58, 59. The step feature 130 engages with the ridge 140 of the seal 120 and inhibits removal of the seal 120 from the outlets 84 and inlets 82 away from the first portion 60 of the dual function manifold 56 and enables the dual function manifold 56 to be removed from the associated battery module 22 with the seals 120 remaining in the dual function manifold 56. The step feature 130 engages with the ridge 140 of the seal 120 and inhibits removal of the seal 120 from the engagement openings 114 away from the first portion 98 of the single function manifold 58 and enables the single function manifold 58 to be removed from the associated battery module 22 with the seals 120 remaining in the single function manifold 58.

Referring to FIG. 2, the coolant supply lines 44 and the coolant return lines 46 have attachment brackets 148 that enable the coolant supply lines 44 and the coolant return lines 46 to be removably attached to the manifolds 48. The attachment brackets 148 include a fastening feature, such as a threaded bolt or an opening that can receive a removable fastener, that aligns with the access feature 104 on the manifold 48 when attaching the coolant supply lines 44 and the coolant return lines 46 to the manifold 48. The connection via attachment brackets 148 instead of the normally used Society of Automotive Engineers (SAE) J2044 Quick Connectors decreases packaging space and increases robustness.

The forming of the manifolds 48 with separately injection molded portions as described above allows the easy inclusion of complex geometry and the inclusion of the above-described features and functionality that could not be created with a single injection molded body. The manifolds 48 being removable from the battery modules 22 and retaining the seals 120 allows for the rechargeable energy storage system 18 to be serviced and leaking seal issues to be fixed by replacing the associated manifold 48 without eliminating the use of the associated battery modules 22. Integration of the seals 120 in the manifolds 48 instead in the temperature regulating components 50 allows for a more simplified design for the regulating components 50 and does not require making a serviceable regulating component 50 to fix a leaking seal 120.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A cooling system manifold for a battery module, the battery module having at least one battery cell and at least one temperature regulating component having a flow path with a feed port to receive coolant and a return port to discharge coolant, the cooling system manifold comprising:
a supply manifold attachable to the battery module for supplying coolant to the at least one temperature regulating component in the battery module, the supply manifold having separately formed a supply manifold first portion connected to a supply manifold second portion to form an internal supply channel, the supply manifold first portion having a supply port that directs coolant into the internal supply channel, the supply manifold second portion having an outlet that directs coolant from the internal supply channel to the feed port;
a first seal disposed within the outlet, the first seal having a first section sealed against the outlet and a second section sealable to the feed port;
a removal manifold attachable to the battery module for removing coolant from the at least one temperature regulating component in the battery module, the removal manifold having separately formed a removal manifold first portion connected to a removal manifold second portion to form an internal removal channel, the removal manifold first portion having a removal port that directs coolant out of the internal removal channel, the removal manifold second portion having an inlet that directs coolant from the return port to the internal removal channel; and
a second seal disposed within the inlet, the second seal having a first section sealed against the inlet and a second section sealable to the return port.

2. The cooling system manifold of claim 1, wherein the supply manifold second portion has multiple attachment sections and the supply manifold second portion attachment sections are attached to the battery module with removable fasteners, and the removal manifold second portion has multiple attachment sections and the removal manifold second portion attachment sections are attached to the battery module with removable fasteners.

3. The cooling system manifold of claim 2, further including compression limiters disposed in the supply manifold second portion attachment sections and in the removal manifold second portion attachment sections, wherein the compression limiters limit compression of the supply manifold attachment sections by the removable fasteners attaching the supply manifold to the battery module and limit compression the removal manifold attachment sections by the removable fasteners attaching the removal manifold to the battery module.

4. The cooling system manifold of claim 2, wherein the supply manifold second portion attachment sections have two alignment holes that receive insertion of alignment pins on the battery module and align the supply manifold with the battery module, and the removal manifold second portion attachment sections have two alignment holes that receive insertion of alignment pins on the battery module and align the removal manifold with the battery module.

5. The cooling system manifold of claim 1, wherein a coolant supply line having a supply attachment bracket supplies coolant to the supply manifold, a coolant return line having a return attachment bracket removes coolant from the removal manifold, the supply manifold first portion has a removable fastener engagement opening adjacent the supply port, the removal manifold first portion has a removable fastener engagement opening adjacent the removal port, the coolant supply line is attached to the supply port with the supply attachment bracket attached to the supply manifold with a fastener in the supply manifold fastener engagement opening, and the coolant return line is attached to the removal port with the return attachment bracket attached to the removal manifold with a fastener in the removal manifold fastener engagement opening.

6. The cooling system manifold of claim 1, wherein the supply manifold first portion and the supply manifold second portion are separately injection molded and include joining elements that join the supply manifold first portion to the supply manifold second portion and forms a seal that maintains coolant in the internal supply channel, the first seal is disposed within the outlet either prior to or after joining together the supply manifold first portion and the supply manifold second portion, the removal manifold first portion and the removal manifold second portion are separately injection molded and include joining elements that join the removal manifold first portion to the removal manifold second portion and forms a seal that maintains coolant in the internal removal channel, and the second seal is disposed within the inlet either prior to or after joining together the removal manifold first portion and the removal manifold second portion.

7. The cooling system manifold of claim 6, wherein the supply manifold first portion includes a back stop formed in the injection molding that aligns with the outlet, wherein the supply manifold back stop limits movement of the first seal in the outlet toward the supply manifold first portion, the removal manifold first portion includes a back stop formed in the injection molding that aligns with the inlet, wherein the removal manifold back stop limits movement of the second seal in the inlet toward the removal manifold first portion.

8. The cooling system manifold of claim 6, wherein the outlet includes an inner surface, the outlet inner surface has a step feature formed in the injection molding, the first seal first section has an outer diameter that contacts the outlet step feature and inhibits removal of the first seal from the outlet away from the supply manifold first portion and enables the supply manifold to be removed from the battery module with the first seal remaining in the supply manifold, and the inlet includes an inner surface, the inlet inner surface has a step feature formed in the injection molding, the second seal first section has an outer diameter that contacts the inlet step feature and inhibits removal of the second seal from the inlet away from the removal manifold first portion and enables the removal manifold to be removed from the battery module with the second seal remaining in the removal manifold.

9. A cooling system manifold for a battery module, the battery module having at least one battery cell and at least one temperature regulating component having a flow path with a feed port to receive coolant and a return port to discharge coolant, the cooling system manifold comprising:
a manifold attachable to the battery module for supplying coolant to and removing coolant from the at least one temperature regulating component in the battery module, the manifold having separately formed a manifold first portion connected to a manifold second portion to form an internal supply channel and an internal removal channel, the manifold first portion having a supply port that directs coolant into the internal supply channel and a removal port that directs coolant out of the internal removal channel, the manifold second portion having an outlet that directs coolant from the internal supply channel to the feed port and an inlet that directs coolant from the return port to the internal removal channel;
a first seal disposed within the outlet, the first seal having a first section sealed against the outlet and a second section sealable to the feed port; and
a second seal disposed within the inlet, the second seal having a first section sealed against the inlet and a second section sealable to the return port.

10. The cooling system manifold of claim 9, wherein the manifold second portion has multiple attachment sections and the attachment sections are attached to the battery module with removable fasteners.

11. The cooling system manifold of claim 10 further including compression limiters disposed in the attachment sections, wherein the compression limiters limit compression of the attachment sections by the removable fasteners attaching the manifold to the battery module.

12. The cooling system manifold of claim 10, wherein the attachment sections have two alignment holes that receive insertion of alignment pins on the battery module and align the manifold with the battery module.

13. The cooling system manifold of claim 9, wherein a coolant supply line having a supply attachment bracket supplies coolant to the manifold, a coolant return line having a return attachment bracket removes coolant from the manifold, the manifold first portion has a removable fastener engagement opening adjacent the supply port, the manifold first portion has a removable fastener engagement opening adjacent the removal port, the coolant supply line is attached to the supply port with the supply attachment bracket attached to the manifold with a fastener in the fastener engagement opening adjacent the supply port, and the coolant return line is attached to the removal port with the return attachment bracket attached to the manifold with a fastener in the fastener engagement opening adjacent the removal port.

14. The cooling system manifold of claim 9, wherein the manifold first portion and the manifold second portion are separately injection molded and include joining elements that join the manifold first portion to the manifold second portion and forms a seal that maintains coolant in the internal supply channel and in the internal removal channel, the first seal is disposed within the outlet either prior to or after joining together the manifold first portion and the manifold second portion, and the second seal is disposed within the inlet either prior to or after joining together the manifold first portion and the manifold second portion.

15. The cooling system manifold of claim 14, wherein the manifold first portion includes back stops formed in the injection molding that align with the outlet and the inlet, wherein the back stops limit movement of the first seal in the outlet toward the first portion and the second seal in the inlet toward the first portion.

16. The cooling system manifold of claim 14, wherein the outlet includes an inner surface, the outlet inner surface has a step feature formed in the injection molding, the first seal first section has an outer diameter that contacts the outlet step feature and inhibits removal of the first seal from the outlet away from the first portion and enables the manifold to be removed from the battery module with the first seal remaining in the manifold, and the inlet includes an inner surface, the inlet inner surface has a step feature formed in the injection molding, the second seal first section has an outer diameter that contacts the inlet step feature and inhibits removal of the second seal from the inlet away from the first portion and enables the manifold to be removed from the battery module with the second seal remaining in the manifold.

17. A battery module comprising:
a battery tray;
a plurality of battery cells supported on the battery tray;
a plurality of temperature regulating components each having a flow path with a feed port and a return port to receive and discharge coolant;
a cooling assembly comprising:
a manifold attachable to the battery module for supplying coolant to and removing coolant from the temperature regulating components in the battery module, the manifold having separately formed a manifold first portion connected to a manifold second portion to form an internal supply channel and an internal removal channel, the manifold first portion having a supply port that directs coolant into the internal supply channel and a removal port that directs coolant out of the internal removal channel, the manifold second portion having outlets that direct coolant from the internal supply channel to the feed ports and inlets that direct coolant from the return ports to the internal removal channel;
first seals disposed within the outlets, the first seals having a first section sealed against the outlet and a second section sealable to the feed port; and
second seals disposed within the inlets, the second seals having a first section sealed against the inlet and a second section sealable to the return port.

18. The battery module of claim 17, further comprising a coolant supply line having a supply attachment bracket that supplies coolant to the manifold and a coolant return line having a return attachment bracket that removes coolant from the manifold, the manifold first portion has a removable fastener engagement opening adjacent the supply port, the manifold first portion has a removable fastener engagement opening adjacent the removal port, the coolant supply line is attached to the supply port with the supply attachment bracket attached to the manifold with a fastener in the fastener engagement opening adjacent the supply port, and the coolant return line is attached to the removal port with the return attachment bracket attached to the manifold with a fastener in the fastener engagement opening adjacent the removal port.

19. The battery module of claim 17, wherein the manifold first portion and the manifold second portion are separately injection molded and include joining elements that join the manifold first portion to the manifold second portion and forms a seal that maintains coolant in the internal supply channel and in the internal removal channel, the first seals are disposed within the outlets either prior to or after joining together the manifold first portion and the manifold second portion, and the second seals are disposed within the inlets either prior to or after joining together the manifold first portion and the manifold second portion.

20. The battery module of claim 19, wherein the manifold first portion includes back stops formed in the injection molding that align with the manifold second portion outlets and inlets, wherein the back stops limit movement of the first seals in the outlets toward the first portion and the second seals in the inlets toward the first portion, the outlets include an inner surface, the outlet inner surfaces have a step feature formed in the injection molding, the first seal first sections have an outer diameter that contacts the outlet step features and inhibits removal of the first seals from the outlets away from the first portion and enables the manifold to be removed from the battery module with the first seals remaining in the manifold, and the inlets include an inner surface, the inlet inner surfaces have a step feature formed in the injection molding, the second seal first sections have an outer diameter that contacts the inlet step features and inhibits removal of the second seals from the inlets away from the first portion and enables the manifold to be removed from the battery module with the second seals remaining in the manifold.
